(19) United States
(12) Patent Application Publication
(10) Pub. No.: US 2007/0183458 A1
(43) Pub. Date: Aug. 9, 2007

(54) System and method for using scalable session initiation and termination in mobile broadcast/multicast services

(75) Inventors: Imed Bouazizi, Tampere (FI); Ramakrishna Vedantham, Irving, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/348,026

(22) Filed: Feb. 6, 2006

(51) Int. Cl. H04J 3/00

(52) U.S. Cl. 370/498

(57) ABSTRACT

An improved system and method for scheduling Join or Leave operations in a MBMS system. When a Join operation or a Leave operation is initiated by user equipment, it is determined whether the current time is within a protection period. If the current time is within a protection period, a first random time is calculated and an operation message is scheduled for transmission at the first random time. If the current time is outside of a protection but within an allowed period, the operation message is scheduled for immediate transmission. If the current time is outside of a protection and outside of the allowed period, a second random time is calculated and the operation message is scheduled to be sent at the second random time.

### FIELD OF THE INVENTION

The present invention relates generally to mobile broadcast/multicast services (MBMS). More particularly, the present invention relates to the efficient implementation of Join and Leave operations in MBMS systems.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

MBMS is a point-to-multipoint service in which data is transmitted from a single source to multiple destinations at the same time. MBMS is used for the efficient sharing of network resources when transmitting the same data to several receivers. As shown in FIG. 1, the MBMS system can be divided into three functional layers: a bearer service 100, a delivery method 110, and user services 120. The MBMS bearer service 100 provides the mechanisms to transport multicast and broadcast IP data to User Equipments (UE) efficiently. The delivery method 110 can either comprise a download delivery method 112 or a streaming delivery method 114. Delivery methods may use one or many MBMS bearer services, as well as point-to-point bearers, to deliver data. User services 120 enable applications on top of MBMS and may use one to many delivery methods to deliver the application data.

MBMS sessions are set up between a broadcast-multicast service center (BM-SC), a gateway General Packet Radio Service (GPRS) support node (GGSN), and the UE. The MBMS delivery method is triggered by the MBMS user service provider. An MBMS session can comprise multicast or broadcast sessions. In the broadcast mode, the UE performs a local activation of the service independently of the session start at the BM-SC. FIG. 2 depicts the procedure of an MBMS broadcast session, with the session including a service announcement phase 200, a session start phase 210, a MBMS notification phase 220, a data transfer phase 230 and a session stop phase 240.

In the multicast mode (depicted in FIG. 3), the UE has to first subscribe to the service. Once subscribed (which occurs at step 300), the UE is then able to receive service announcements at step 310, which are sent over the multicast bearer or over an interaction channel. After receiving and extracting the necessary information about the service from the service description metadata, the UE will perform a “Join” operation at step 320 to the service as depicted in FIG. 4. The Join operation involves joining the specific multicast group(s) so that the network will forward the specific multicast data to the UE.

At the start of a session (step 330), the BM-SC informs the network about the imminent data transmission. The MBMS notification phase is represented at 340 in FIG. 3. This information is propagated from the GGSN, over the Serving GPRS support node (SGSN), the base station controller/radio network controller (BSC/RNC), and down to the UE. The UE receives paging notifications about the start of the session. This procedure is common in both multicast and broadcast modes, after which data transfer 350 is enabled. The session can be either terminated by the BM-SC or the UE. The BM-SC sends a “Session Stop” request at 360 to the network to indicate the end of the session. This information is propagated down to the UE. The UE may also choose to leave the session prematurely by sending an “IGMP Leave” message to the GGSN at 370. “IGMP” refers to the Internet Group Multicast Protocol.

For a particular session, the UE must retrieve the service description from the metadata carried during the session announcement in order to extract the time of the session. The session description will carry the session start and end time as a field of the Session Description Protocol (SDP) file. This time represents a network time protocol (NTP) timestamp. The NTP timestamp is the amount of seconds that have elapsed since the 1 Jan. 1900. The NTP timestamp is usually represented by a 32 bit field (optionally with a 32 bit second fraction field).

During the multicast of a popular event, such as a major sporting event, over MBMS, a very large number of users are expected to consume the service. In such a situation, UEs may be oriented to perform the Join operation at the indicated session start time, if not otherwise instructed by the BM-SC. This can cause a situation where the network is overloaded. The same problem can occur at the end of the session, when UEs initiate the “Leave” procedure at the session end time. This issue is discussed in Section 4.4.2 of the 3GPP TS 23.246 V6.8.0, “3^{rd} Generation Partnership Project; Technical Specification Group Services and System Aspects; Multimedia Broadcast/Multicast Service (MBMS); Architecture and functional description (Release 6)”, September 2005. This section is as follows:

4.4.2 Multicast Mode Timeline

4.4.2.1 Period between Service Announcement and Session Start

The service announcement may contain a schedule of Session Start times and may be sent some time before the service is due to start. So, this time period could be hours, days or even weeks.

4.4.2.2 Period between Service Announcement and Service Subscription

Service Subscription can be done anytime before or after Service announcement.

4.4.2.3 Period between Service Announcement and Joining

The Joining time is chosen by the user and/or UE possibly in response to a Service Announcement. Users will typically Join at the time of their choosing so that the period between announcement and Joining may be very long or very short. In order to avoid overload situations being caused by many users attempting to Join in a short period of time, the UE shall be able to use parameters sent by the BM-SC in the service announcement to randomize the Joining time.

4.4.2.4 Period between Joining and Session Start

Some MBMS bearer services may be ‘always on’. In this case, Joining can take place immediately after Service Announcement and possibly many hours before, or after, Session Start.

In other cases, if a Session Start time is known, Joining may take place immediately before Session Start or after Session Start. For these services, the announcement may contain some indication of a time period which users and UEs should use to choose a time to Join the MBMS bearer service.

4.4.2.5 Period between Session Start and First Data Arrival

Session Start indicates that the transmission is about to start. The time delay between a Session Start indication and actual data should be long enough for the network actions required at Session Start to take place e.g. provision of service information to the UTRAN, establishment of the bearer plane.

Session Start may be triggered by an explicit notification from the BM-SC. In the case of bearer plane resources which are set-up after the start of session data transmission, the network is not required to buffer the session data and loss of data can be assumed.

4.4.2.6 Period between Session Start and Session Stop

When the BM-SC knows that there is no more data to be sent for a “long idle period”, it should indicate Session Stop to the network, causing the release of bearer resources. However, if this idle period with no data is short, this may not be appropriate as it brings more signaling and processing. The duration of this “long idle period” is implementation dependent. The order of magnitude should be defined to take into account network constraints (including UTRAN, GERAN, and CN). If the BM-SC wants to use session repetition identification on the MBMS bearer service level, the BM-SC must stop the MBMS session before starting the next MBMS user service session for that TMGI.

Section 4.4.2.3 indicates that the UE should be able to use parameters sent by the BM-SC in the service announcement to randomize the Joining time. Section 7.2.3 of the 3GPP TS 23.246 V6.8.0, “3^{rd} Generation Partnership Project; Technical Specification Group Services and System Aspects; Multimedia Broadcast/Multicast Service (MBMS); Architecture and functional description (Release 6)”, September 2005 also mentions that session Joining, triggered by service announcements, needs to be spread over time. The parameters for time dispersion need to be signaled in the session announcement. However the only related information provided in the service announcement, as described in 3GPP TR 23.846 V6.1.0, “3^{rd} Generation Partnership Project; Technical Specification Group Services and System Aspects; Multimedia Broadcast/Multicast Service (MBMS); Architecture and functional description (Release 6)”, December 2002, is the session start and end time in the SDP file.

There is currently no solution that handles the issue of randomizing the Join and Leave operations in multicast/broadcast networks. In IETF RFC 1112, S. Deering, “Host Extensions for IP Multicasting”, August 1989, an algorithm was proposed for multicast group membership reporting. Under this proposal, Multicast receivers report their interest on a given multicast group back to the multicast router upon receiving a request. In this proposal, a multicast router periodically multicasts requests indicating the multicast group of interest. The receivers that are interested in that specific multicast group randomly select a reporting time between 0 and D seconds and set a timer accordingly. Upon expiry of that timer, the receiver generates a report and sends it to the group multicast address of interest. However, if a receiver detects that another receiver has already reported membership, no report will be generated. This will make sure that only one membership report is generated as a reply to a request.

In 3GPP TR 23.846 V6.1.0, “3^{rd} Generation Partnership Project; Technical Specification Group Services and System Aspects; Multimedia Broadcast/Multicast Service (MBMS); Architecture and functional description (Release 6)”, December 2002, a Backoff Timing algorithm is communicated and permits the UE to calculate a uniformly distributed random time and random server at/to which a repair request is sent. The information about this algorithm is communicated to the UE within the Associated Delivery Procedure description during the user service discovery or announcement or later as part of the session content. The algorithm includes two parts: randomization over time and randomization of the repair server. For randomization over time, the BM-SC notifies the UE about the existence of a post-repair service and signals the parameters “offsetTime” and “randomTimePeriod” for the UE to randomly select a random time at which the request is sent. The UE runs a uniformly distributed random number generator to generate a number between 0 and randomTimePeriod and adds to it the offsetTime to get the time at which it can send its repair requests after the file download/session has ended. For the randomization of the repair server, the BM-SC sends a list of repair server URIs within the Associated Delivery Procedure description. The UE runs a uniformly distributed random number generator to select a random server out of the list of repair servers.

In both of the systems described above, however, there is no discussion or teaching of a system randomizing Join and Leave operations in multicast/broadcast networks.

### SUMMARY OF THE INVENTION

The present invention provides an algorithm for the determination of the time to perform a Join or Leave operation. The corresponding signaling, which might be performed in the session discovery/announcement metadata, is also defined. Upon starting a Join operation, the UE checks if the current time is inside a protection period. If the current time is inside a protection period, then the UE calculates a random time using the current time instant, a designated randomTimePeriod and a uniformly distributed randomly generated a value between designated values. The UE then schedules the Join message to be sent at that specified time. If the current time is before the session join start time, then a random time instant for sending the Join message is calculated based on the session join start time, a designated protectionPeriod, and a uniformly distributed random number α. If the current time is within the allowed time and not in a protection period, then the Join request is sent immediately. A similar process is used to determine the time to perform a Leave operation.

With the present invention, Join and Leave requests are dispersed over time during a protection period so that the overall scalability of the system is improved. Requests outside of protection periods are considered as already randomly dispersed. As prior proposals have identified the need for an algorithm to improve the scalability of Join and Leave requests, this issue has not been previously addressed. Therefore, the present invention fills a gap which has been previously identified but not addressed.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of the functional layers of conventional MBMS service delivery;

FIG. 2 is a depiction of the individual phases of a MBMS broadcast service provision;

FIG. 3 is a depiction of the individual phases of a MBMS multicast service provision;

FIG. 4 is a representation showing a process for activating a MBMS multicast service;

FIG. 5 is a chart showing the process of implementing time dispersed Join requests according to one embodiment of the present invention;

FIG. 6 is a chart showing the process of implementing time dispersed Leave requests according to one embodiment of the present invention;

FIG. 7 is a flow chart showing the process by which the time to perform a Join operation is determined according to one embodiment of the present invention;

FIG. 8 is a flow chart showing the process by which the time to perform a Join operation is determined according to one embodiment of the present invention;

FIG. 9 is a perspective view of a mobile telephone that can be used in the implementation of the present invention; and

FIG. 10 is a schematic representation of the circuitry of the mobile telephone of FIG. 8.

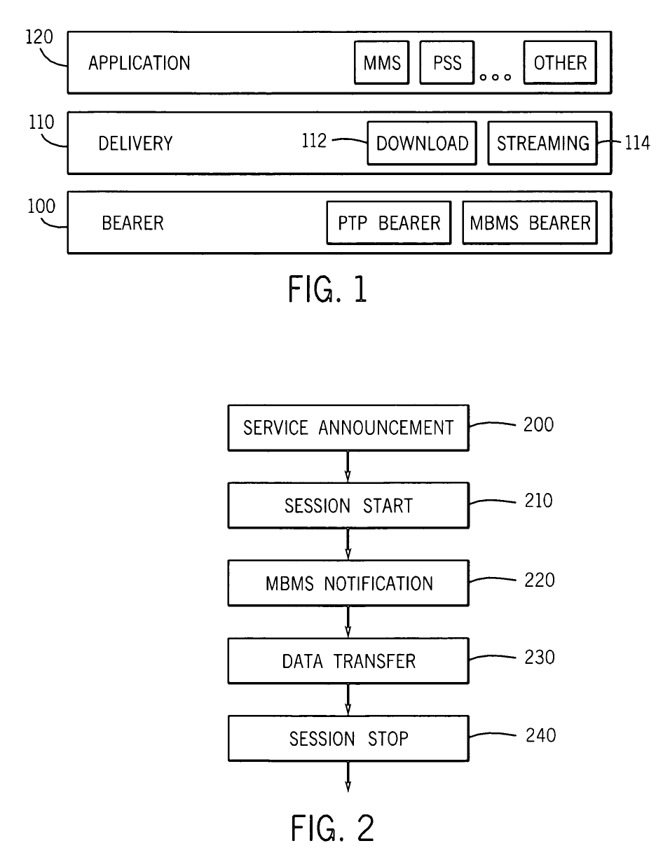

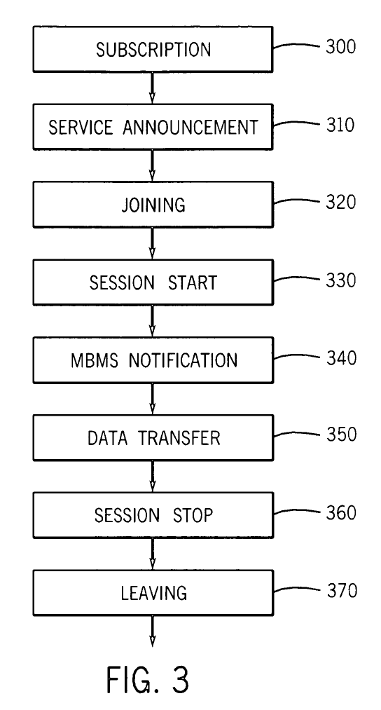

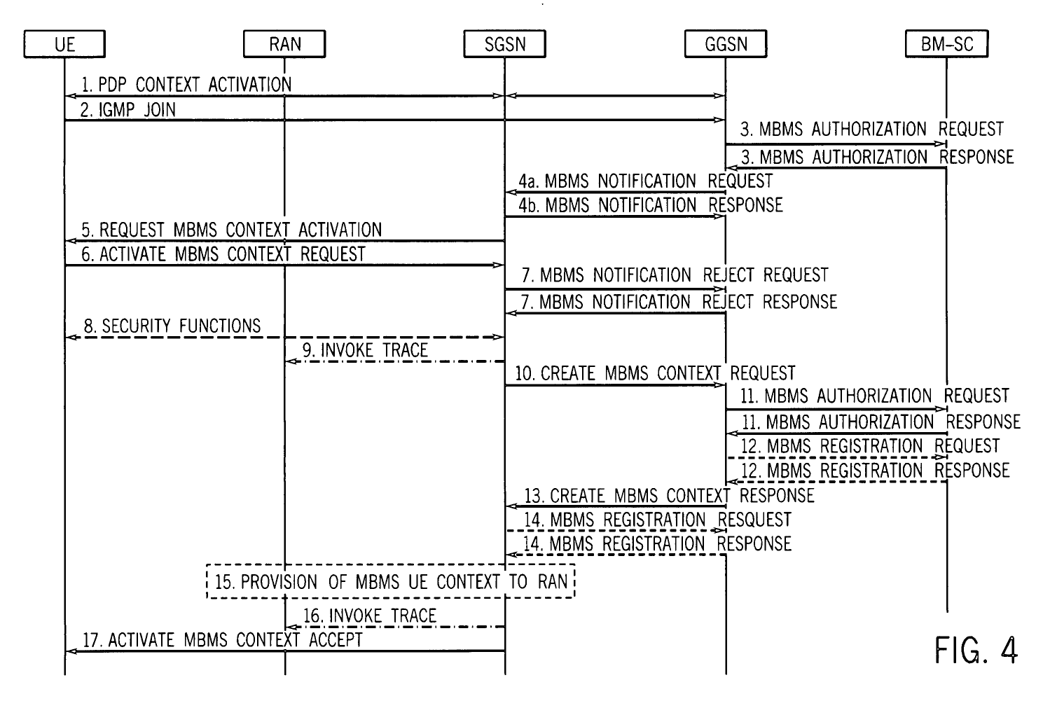

### DETAILED DESCRIPTION OF THE PREFERRED EMBODIMENTS

The present invention provides an algorithm for the determination of the time to perform a Join or Leave operation. The corresponding signaling, which may be performed in the session discovery/announcement metadata, is also defined.

Upon receiving a service announcement message, the UE updates its database of the service guide. The user will usually be prompted for interest in this service, or the user will select the service after browsing through the service guide at a later time. This user action triggers the Join procedure at the UE. A “Session leave” operation can occur prematurely on the wish of the user, or it can be automatically initiated after the session end time has been reached.

According to one embodiment of the present invention, two types of session join and leave operations are identified: immediate and deferred operations. Immediate operations are performed immediately, and deferred operations are delayed using a random time.

Immediate operations are performed if the Join or Leave operations are triggered outside of the protection periods but during the allowable session join/leave time period. The allowable session join time is the time between the session join start time and the session end time. For Leave operations, the allowable session leave time is the time starting after the session join start time and reaching up to an arbitrary time after the session end time. If the session Join/Leave operation is triggered outside of these allowable time periods, then the operations should be deferred to a random point of time after the start of the time allowable period.

Deferred operations are performed if the Join/Leave operation is triggered during the protection period. This can occur, for example, if the UE decides to automatically join a session for which a service announcement has just been received. This can also occur if the user decides to receive the service during the protection period, or if the UE is switched on and detects that a scheduled Join operation was missed and a protection period is in progress.

There are 3 different protection periods that may overlap. The first period is a protection period starting at the session join start time. The second period is a protection period immediately before the session start time. The third period is a protection period starting at the session end time. In some embodiments of the invention, the duration of the protection periods may be different from each other. In the event that two or more of the protection periods overlap, the start time for the protection period is the earliest start time of the overlapping protection periods, and the end time of the protection period is the latest end time of the overlapping protection periods.

In the session announcement, an indication of the join start time may be indicated to the UEs. The join start time is the time from which GGSN and BM-SC are willing to receive and process Join requests for a given multicast group. During a protection period, the UE uses the current time at which the operation is triggered as the basis to calculate a random time instant and to schedule the operation at that time instant. If the operation is triggered outside of the allowed time, then the reference time is the session join start time or any other reference time depending on the operation. The UE uses a Random Time Period value that is extracted from the service discovery/announcement metadata to calculate a random time.

The following equations show how potential values of the random time for sending a Join request are calculated:
JoinTime=t_{current}+(α×randomTimePeriod)
or
JoinTime=joinStartTime+(β×protectionPeriod)

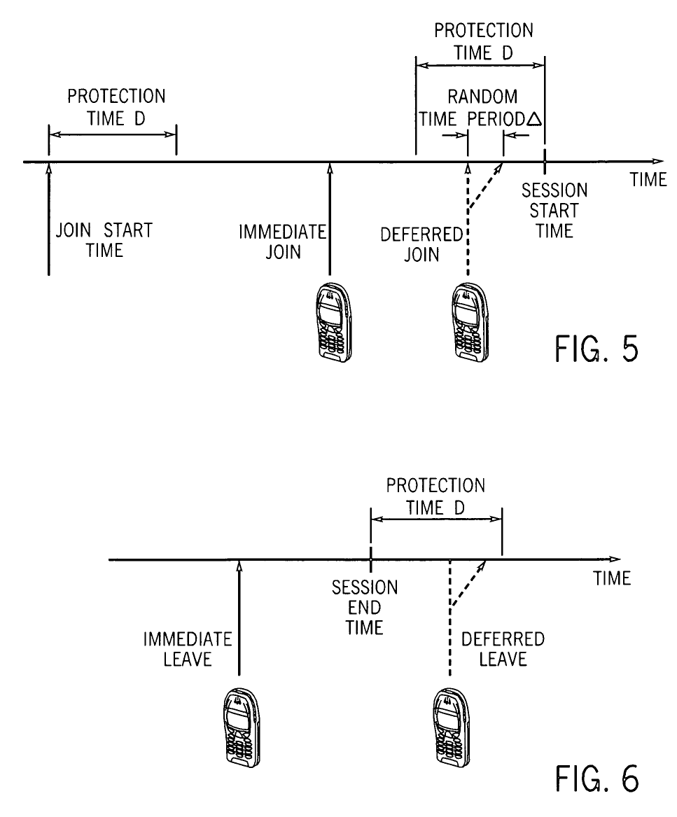

In these equations, t_{current} is the current time at which the operation is triggered, RandomTimePeriod is the Random Time Period indicated to the UE by the network, BM-SC, or otherwise preconfigured in the UE. α and β are random real numbers between 0 and 1 that may be calculated using a random number generator. ProtectionPeriod is the duration of the protection period. If the UE cannot perform the Join operation at the scheduled time (e.g. because it was turned off or out of coverage), the UE checks whether it is in a protection period or not as soon as it can perform Join operations again. If it is in a protection period, it should defer its Join operation according to the first equation. The second equation applies for operations that are triggered outside of the allowable time, for example before Join start time. The behavior for Join operations is depicted in FIG. 5.

The time calculation for sending the Leave request according to one embodiment of the invention is similar. If the leave operation is triggered before the scheduled session end time, the UE checks whether it is in a protection period or not.

If not, then the UE sends its Leave request immediately. If it is in a protection period, then the UE defers its Leave operation according to the following equation:
LeaveTime=t_{current}+(δ×RandomTimePeriod)
The UE automatically schedules a Leave operation at a random time after the session end time according to the following equation:
LeaveTime=sessionEndTime+(ε×protectionPeriod)

In these equations, δ and ε are random real numbers between 0 and 1 that may be calculated using a random number generator.

UEs are allowed to join and leave during the session, in which case immediate operations are performed. The behavior for Leave operations is depicted in FIG. 6.

If a user service is making use of several multicast IP addresses, multiple Joins/Leaves need to be performed at the session start. In such a case, it is possible to use the same algorithm to schedule all Join/Leave requests of a certain UE at the same time.

The BM-SC needs to take into account the previous algorithm and other delaying factors, such as the connection setup time, in order to determine the time between the session start and the start of data transmission. This is discussed in detail in section 4.4.2.5 of the 3GPP TS 23.246 V6.8.0, “3^{rd} Generation Partnership Project; Technical Specification Group Services and System Aspects; Multimedia Broadcast/Multicast Service (MBMS); Architecture and functional description (Release 6)”, September 2005. Depending on the type of the timing algorithm, the data transmission should start at least after the expiry of latest possible timer, which is tₛₜₐᵣₜ+RandomTimePeriod.

The parameters of the time selection algorithm may be signaled in the session announcement metadata, during session discovery, or elsewhere, such as in a website describing the service, in an SMS or MMS for service description, etc.

For the implementation of one embodiment of the present invention, the UE extracts the information related to the timing algorithm from the service discovery/announcement metadata, or from another location where the information is available. The UE then updates its service guide or presents the information to the user. The user may express its interest in the service on request, or it may configure the UE to automatically join some services. In the case where the user expresses its interest upon request, the Join operation may be triggered at a later time. In the case where the UE is configured to automatically join certain services, it can initiate the Join operation immediately upon reception of the announcement message.

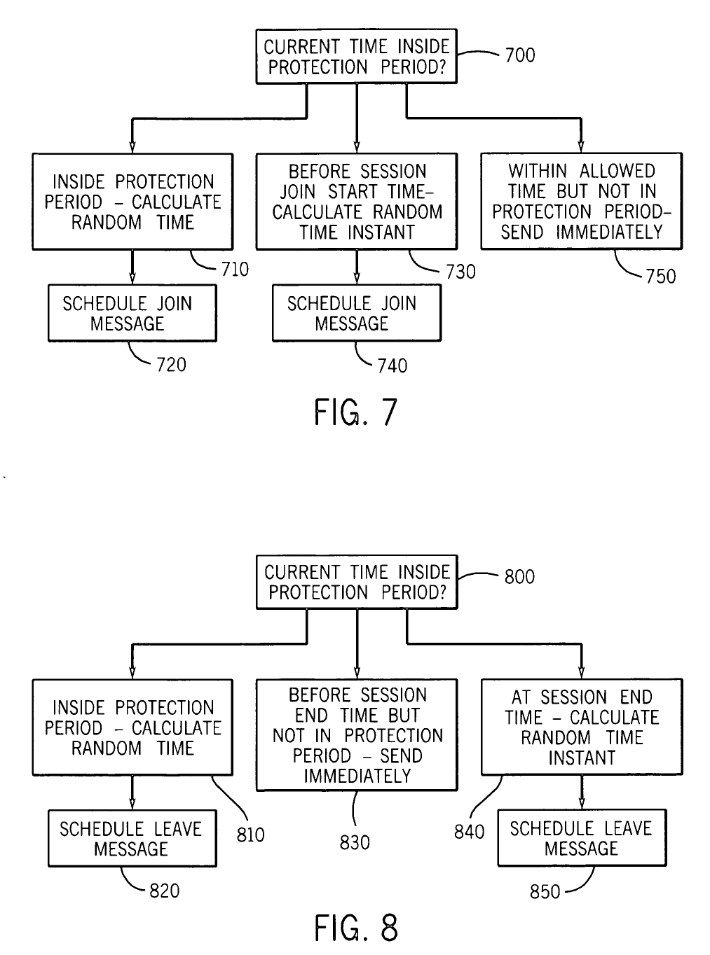

As depicted in FIG. 7, upon starting the Join operation, the UE checks at step 700 if the current time is inside a protection period. If the current time is inside a protection period, then at step 710, the UE calculates a random time using the current time instant, the randomTimePeriod and a randomly generated a value between 0 and 1, which may be uniformly distributed or may follow any other distribution. The UE then schedules the Join message to be sent at that specified time at step 720. If the current time is before the session join start time (i.e., outside of both the protection period and an allowable period), then a random time instant for sending the Join message is calculated at step 730 based on the session join start time, protectionPeriod, and a random number β between 0 and 1, which may be uniformly distributed or may follow any other distribution. A Join message is then scheduled at step 740. If the current time is within the allowed time period but not in a protection period, then the Join request is sent immediately, as represented at step 750.

Similarly, FIG. 8 is a flow chart showing the process by which Leave requests are performed. At 800, it is determined if the current time (i.e., the time at which the leave operation is triggered or initiated either by a user decision or by some other event) is outside of the protection period. If the current time is within the protection period, then a random time is calculated for sending the Leave request at step 810 based on the current time, the RandomTimePeriod, and a random number δ between 0 and 1, which may be randomly distributed or may follow any other distribution. The UE then schedules the Leave message to be sent at that specified time at step 820. In one embodiment of the invention, the Leave operation can be defined to always be initiated by the session end time given in the SDP file. In that case, a random time instant for sending the Leave message is calculated at step 840 based on the session end time, protectionPeriod, and a random number ε between 0 and 1, which may be uniformly distributed or may follow any other distribution. The Leave message is then scheduled at step 850. If the current time is before the session end time (i.e., within an allowable period) and not in a protection period, then the Leave request is sent immediately, as represented at step 830 and the automatically scheduled transmission of the Leave message is cancelled.

It should be noted that the generation of the random time instant can be implemented differently for optimization purposes. For example, if the generation of a random number between 0 and 1 is found to be less efficient, then another implementation of this process may be used.

The following is metadata of a service description for implementing one embodiment of the present invention.

<?xml version=″1.0″ encoding=″UTF-8″?>
<xs:schema xmlns=″urn:3GPP:metadata:2005:MBMS:userServiceDescription″
xmlns:xs=http://www.w3.org/2001/XMLSchema
targetNamespace=″urn:3GPP:metadata:2005:MBMS:userServiceDescription″
elementFormDefault=″qualified″>
<xs:element name=″bundleDescription″ type=″bundleDescriptionType″/>
<xs:complexType name=″bundleDescriptionType″>
<xs:sequence>
<xs:element name=″userServiceDescription″ type=″userServiceDescriptionType″
maxOccurs=″unbounded″/>
<xs:element name=”randomJoinLeave” type=”randomJoinLeaveType” minOccurs=”0”
maxOccurs=”1”/>
<xs:any namespace=″##other″ minOccurs=″0″ maxOccurs=″unbounded″ processContents=″lax″/>
</xs:sequence> <xs:attribute name=″fecDescriptionURI″ type=″xs:anyURI″ use=″optional″/>
<xs:any Attribute processContents=″skip″/>
</xs:complexType>
<xs:complexType name=″userServiceDescriptionType″>
<xs:sequence>
<xs:element name=″name″ type=″nameType″ minOccurs=″0″ maxOccurs=″unbounded″/>
<xs:element name=″serviceLanguage″ type=″xs:language″ minOccurs=″0″
maxOccurs=″unbounded″/>
<xs:element name=″deliveryMethod″ type=″deliveryMethodType″ maxOccurs=″unbounded″/>
xs:element name=″accessGroup″ type=″accessGroupType″ minOccurs=″0″
maxOccurs=″unbounded″/>
<xs:element name=”randomJoinLeave” type=”randomJoinLeaveType” minOccurs=”0”
maxOccurs=”1”/>
<xs:any namespace=″##other″ minOccurs=″0″ maxOccurs=″unbounded″ processContents=″lax″/>
</xs:sequence>
<xs:attribute name=″serviceId″ type=″xs:anyURI″ use=″required″/>
<xs:any Attribute processContents=″skip″/>
</xs:complexType>
<xs:complexType name=″accessGroupType″>
<xs:sequence>
<xs:element name=″accessBearer″ type=″xs:string″ maxOccurs=″unbounded″/>
</xs:sequence>
<xs:attribute name=″id″ type=″accessGroupIdType″ use=″required″/>
</xs:complexType>
<xs:complexType name=″deliveryMethodType″>
<xs:sequence>
<xs:any namespace=″##other″ minOccurs=″0″ maxOccurs=″unbounded″ processContents=″lax″/>
</xs:sequence>
<xs:attribute name=″accessGroupId″ type=″accessGroupIdType″ use=″optional″/>
<xs:attribute name=″associatedProcedureDescriptionURI″ type=″xs:anyURI″ use=″optional″/>
<xs:attribute name=″protectionDescriptionURI″ type=″xs:anyURI″ use=″optional″/>
<xs:attribute name=″sessionDescriptionURI″ type=″xs:anyURI″ use=″required″/>
<xs:any Attribute processContents=″skip″/>
</xs:complexType>
<xs:complexType name=″nameType″>
<xs:simpleContent>
<xs:extension base=″xs:string″>
<xs:attribute name=″lang″ type=″xs:language″ use=″optional″/>
</xs:extension>
</xs:simpleContent>
</xs:complexType>
<xs:complexType name=”randomJoinLeaveType”>
<xs:attribute name=”joinStartTime” type=”xs:unsignedInteger” use=”optional”/>
<xs:attribute name=”protectionPeriod” type=”xs:unsignedInteger” use=”optional”/>
<xs:attribute name=”randomTimePeriod” type=”xs:unsingedInteger” use=”optional”/>
</xs:complexType>
<xs:simpleType name=″accessGroupIdType″>
<xs:restriction base=″xs:nonNegativeInteger″>
</xs:restriction>
</xs:simpleType>
</xs:schema>

Information fields may be added to the userServiceDescription or to the bundleDescription as a whole to indicate the randomTimePeriod and protectionPeriod values used for the time calculation. Another information field, which can be either an attribute or an element, may indicate the start of session join requests. Default values may be defined for each of these variables so that, in the absence of those values in the metadata, proper scalability mechanisms can operate. The RandomTimePeriod can be the same as the ProtectionPeriod. The joinStartTime can default to the time of the reception of the announcement.

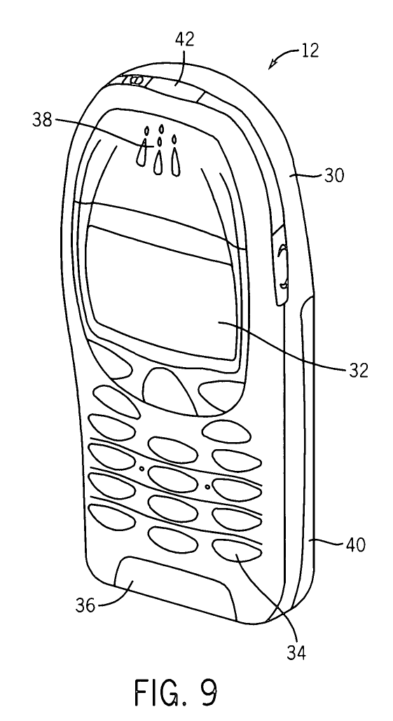

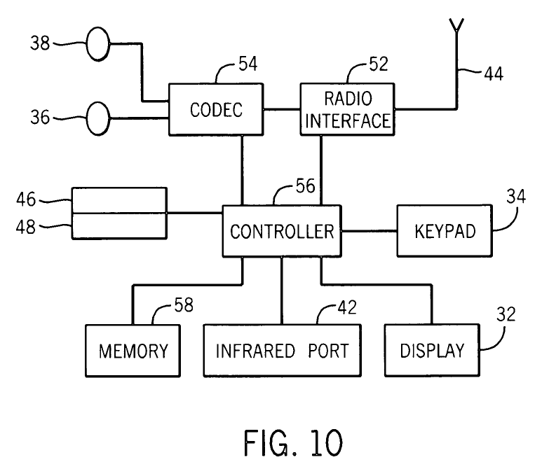

FIGS. 9 and 10 show one representative mobile telephone 12 within which the present invention may be implemented. It should be understood, however, that the present invention is not intended to be limited to one particular type of mobile telephone 12 or other electronic device. The mobile telephone 12 of FIGS. 9 and 10 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of scheduling a Join or Leave procedure in a MBMS system, comprising:
initiating an operation selected from the group consisting of a Join operation and a Leave operation;
determining whether a current time is within a protection period;
if the current time is within a protection period, calculating a first random time and scheduling an operation message to be sent at the first random time;
if the current time is outside of a protection but within an allowed period, immediately transmitting the operation message; and
if the current time is outside of a protection and outside of the allowed period, calculating a second random time and scheduling the operation message to be sent at the second random time.

2. The method of claim 1, wherein the operation comprises a Join operation.

3. The method of claim 2, wherein the first random time is calculated based upon the current time, a randomTimePeriod value and a random number a value between 0 and 1.

4. The method of claim 3, wherein the first random time equals the current time plus (the randomTimePeriod value multiplied by α).

5. The method of claim 2, wherein the second random time for Join operations equals a session join start time plus (the length of the protection period multiplied by β), wherein β is a random value between 0 and 1.

6. The method of claim 1, wherein the operation comprises a Leave operation.

7. The method of claim 6, wherein the first random time is calculated based upon the current time, a randomTimePeriod value and a random δ value between 0 and 1.

8. The method of claim 7, wherein the first random time equals the current time plus (the randomTimePeriod value multiplied by δ).

9. The method of claim 6, wherein the Leave operation is initiated by a session end time representing the beginning of the protection period, the session end time being provided in a SDP file or elsewhere.

10. The method of claim 9, wherein a third random time is calculated based upon the session end time plus (the length of the protection period multiplied by ε), wherein ε is a random value between 0 and 1.

11. The method of claim 1, wherein the first and second random time values are calculated based upon a random time period value that is extracted from service discovery/announcement metadata.

12. A computer program product, included on a computer-readable medium, for scheduling a Join or Leave procedure in a MBMS system, comprising:
computer code for initiating an operation selected from the group consisting of a Join operation and a Leave operation;
computer code for determining whether a current time is within a protection period;
computer code for, if the current time is within a protection period, calculating a first random time and scheduling an operation message to be sent at the first random time;
computer code for if the current time is outside of a protection but within an allowed period, immediately transmitting the operation message; and
computer code for, if the current time is outside of a protection and outside of the allowed period, calculating a second random time and scheduling the operation message to be sent at the second random time.

13. The computer program product of claim 12, wherein the operation comprises a Join operation.

14. The computer program product of claim 13, wherein the first random time is calculated based upon the current time, a randomTimePeriod value and a random number α value between 0 and 1.

15. The computer program product of claim 14, wherein the first random time equals the current time plus (the randomTimePeriod value multiplied by α).

16. The computer program product of claim 13, wherein the second random time for Join operations equals a session join start time plus (the length of the protection period multiplied by β), wherein β is a random value between 0 and 1.

17. The computer program product of claim 12, wherein the operation comprises a Leave operation.

18. The computer program product of claim 17, wherein the first random time is calculated based upon the current time, a randomTimePeriod value and a random number δ value between 0 and 1.

19. The computer program product of claim 18, wherein the first random time equals the current time plus (the randomTimePeriod value multiplied by δ).

20. The computer program product of claim 17, wherein the Leave operation is initiated by a session end time representing the beginning of the protection period, the session end time being provided in a SDP file.

21. The computer program product of claim 20, wherein a third random time is calculated based upon the session end time plus (the length of the protection period multiplied by ε), wherein ε is a random value between 0 and 1.

22. The computer program product of claim 12, wherein the first and second random time values are calculated based upon a random time period value that is extracted from service discovery/announcement metadata.

23. An electronic device, comprising:
a processor; and
a memory unit communicatively connected to the processor and including:
computer code for initiating an operation selected from the group consisting of a Join operation and a Leave operation;
computer code for determining whether a current time is within a protection period;
computer code for, if the current time is within a protection period, calculating a first random time and scheduling an operation message to be sent at the first random time;
computer code for if the current time is outside of a protection but within an allowed period, immediately transmitting the operation message; and
computer code for, if the current time is outside of a protection and outside of the allowed period, calculating a second random time and scheduling the operation message to be sent at the second random time.

24. The electronic device of claim 23, wherein the operation comprises a Join operation.

25. The electronic device of claim 24, wherein the first random time is calculated based upon the current time, a randomTimePeriod value and a random number a value between 0 and 1.

26. The electronic device of claim 25, wherein the first random time equals the current time plus (the randomTimePeriod value multiplied by α).

27. The electronic device of claim 24, wherein the second random time for Join operations equals a session join time plus (the length of the protection period multiplied by β), wherein β is random value between 0 and 1.

28. The electronic device of claim 23, wherein the operation comprises a Leave operation.

29. The electronic device of claim 28, wherein the first random time is calculated based upon the current time, a randomTimePeriod value and a random δ value between 0 and 1.

30. The electronic device of claim 29, wherein the first random time equals the session end time plus (the randomTimePeriod value multiplied by δ).

31. The electronic device of claim 29, wherein the Leave operation is initiated by a session end time representing the beginning of the protection period, the session end time being provided in a SDP file or elsewhere.

32. The electronic device of claim 31, wherein a third random time a calculated based upon the session end time plus (the length of the protection period multiplied by ε), wherein ε is a random value between 0 and 1.
